(19) United States
(12) Patent Application Publication
(10) Pub. No.: US 2020/0049341 A1
(43) Pub. Date: Feb. 13, 2020

(54) EYEWEAR WITH WATER-ACTIVATED ILLUMINATION MEANS

(71) Applicant: Aqua-Leisure Industries, Inc., Avon, MA (US)

(72) Inventor: Steven M. Berenson, Quincy, MA (US)

(73) Assignee: Aqua-Leisure Industries, Inc., Avon, MA (US)

(21) Appl. No.: 16/534,569

(22) Filed: Aug. 7, 2019

Related U.S. Application Data
(60) Provisional application No. 62/715,509, filed on Aug. 7, 2018.

(51) Int. Cl. F21V 33/00; F21V 23/02; F21V 7/00; A63B 33/00

(52) U.S. Cl. CPC F21V 33/008; F21V 23/02; A63B 2207/02; A63B 33/002; F21V 7/00

(57) ABSTRACT

Eyewear having a frame on which certain electrical elements are mounted, including lighting elements that are activated upon contact with water. Preferably the frame is comprised at least in part of translucent material such that, when the lighting elements are activated, they light up the translucent portion of the frame. Each of the lenses of the eyewear may be secured in a plastic eyecup that also lights up when the lighting elements are activated.

### RELATED APPLICATION

This application claims priority under 35 U.S.C. Section 119(e) to U.S. Provisional Application Ser. No. 62/715509 entitled “EYEWEAR WITH WATER-ACTIVATED ILLUMINATION MEANS,” filed on Aug. 7, 2018, which application is hereby incorporated by reference in its entirety for all purposes.

### FIELD OF THE INVENTION

This invention relates to eyewear, including swimming goggles, and particularly to eyewear having lighting elements activated by contact with water, thereby illuminating the frame of the eyewear to provide an attractive and entertaining novelty device for waterside activities.

### SUMMARY OF THE INVENTION

The instant invention comprises eyewear having a frame on which certain electrical elements are mounted, including lighting elements. Preferably the frame is comprised at least in part of translucent material such that, when the lighting elements are activated, they illuminate the translucent portion of the frame. The lighting elements are preferably LEDs. Each of the lenses of the eyewear may be secured in a plastic eyecup that may also light up when the lighting elements are activated.

### DESCRIPTION OF THE DRAWINGS

FIG. 1 depicts eyewear in the form of a pair of googles.

FIG. 2 depicts a top view of the eyewear of FIG. 1.

FIG. 3 depicts the rear of the eyewear frame.

FIG. 4 depicts an eyecup for the eyewear

FIG. 5 depicts an eyecup and lens affixed to the frame.

FIG. 6 is a diagram of circuitry suitable for the purpose of the invention.

### DETAILED DESCRIPTION OF THE INVENTION

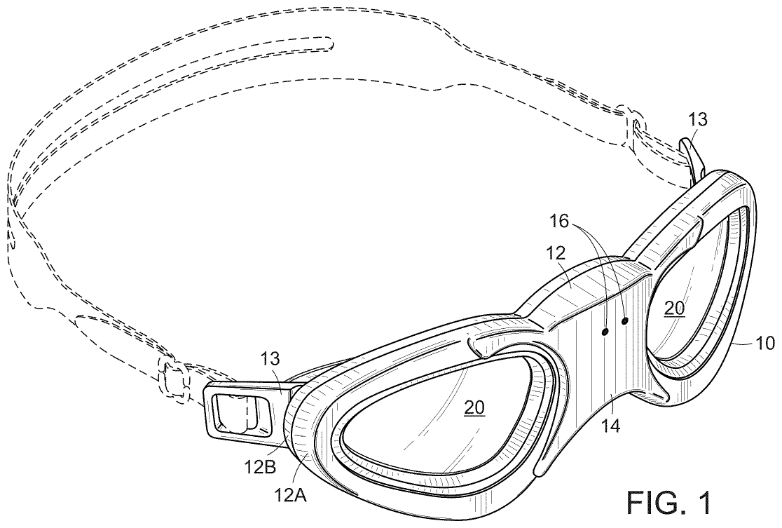

FIG. 1 depicts one aspect of the invention in the form of a pair of swimming goggles. Eyewear 10 is comprised of frame 12, lenses 20, and a conventional strap (illustrated in dashed lines) attached to frame extensions 13 to secure the eyewear to the head of the user. As explained below, four LEDS may be mounted within the frame 12, preferably in the area of the nose bridge 14, although the lighting elements could be more or fewer in number and could be located elsewhere, including on any outer surface of the frame. A reflecting filament (not shown) may be positioned proximate to or around each lens and configured to receive and reflect light from the lighting elements.

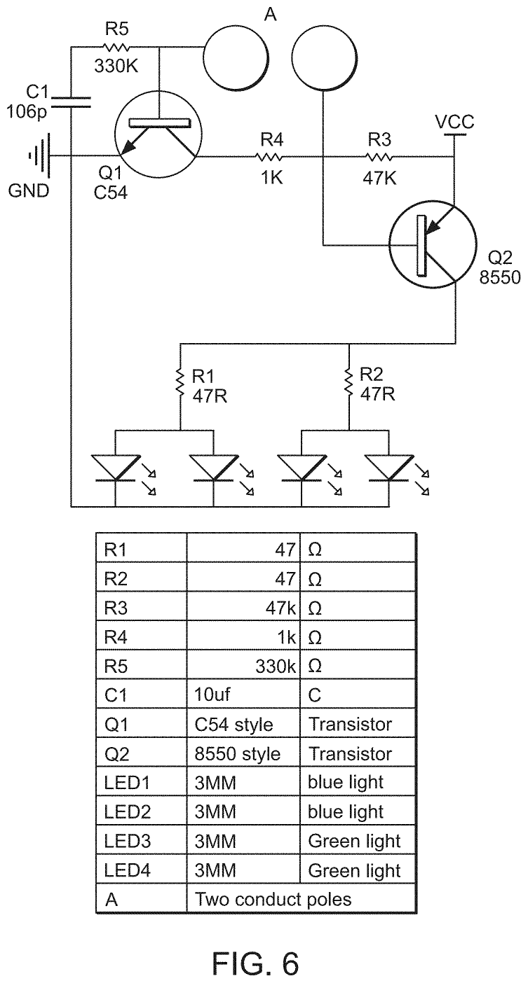

The two small circular areas shown on nose bridge 14 at the front of frame 12 are the contact poles 16 connected to the electrical circuitry (See elements A in FIG. 6). When the contact poles are immersed in water, an electrical connection is made between the poles, thereby completing the electrical circuit to cause illumination of the LEDs. An O-ring or gasket (not shown) affixed to each of the two contact poles 16 prevents water from entering into the frame.

In one aspect of the invention, frame 12 is made of two translucent plastic members 12A and 12B affixed together by conventional means and having an interior space between them. The light emitted by the LEDs mounted within the frame 12 will reflect around the interior of the frame. For added comfort, the frame may be made of soft, flexible plastic material like that of eyecups 18, described below. As previously indicated, the lighting elements may be located elsewhere in or on the frame, including on the sides or in the rear of the frame.

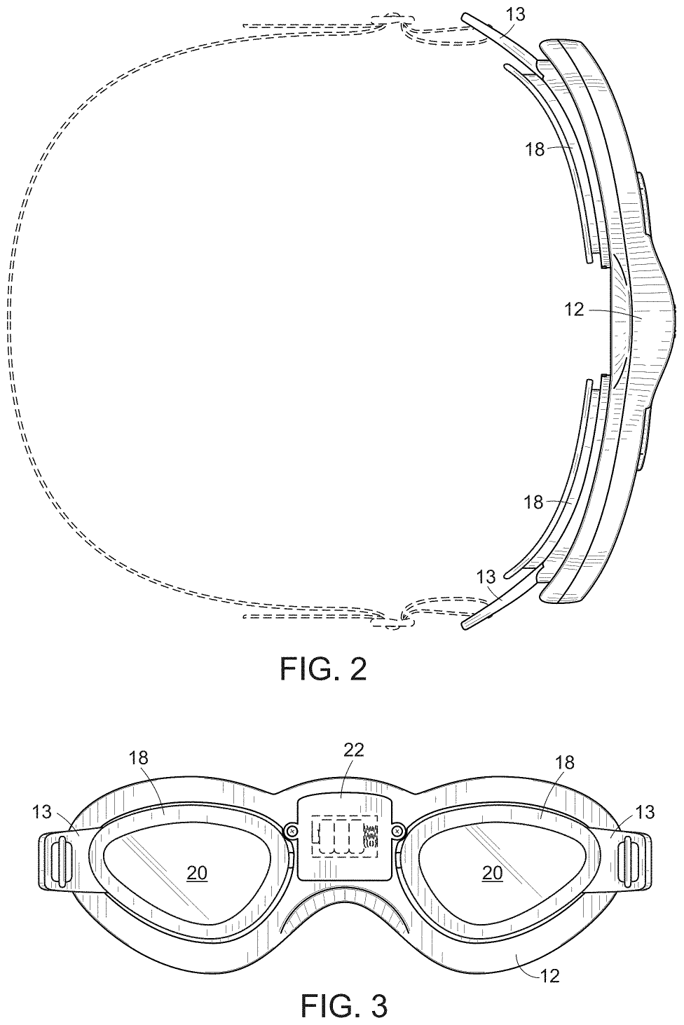

Turning to FIG. 2, eyecups 18 are attached to and surround the lens elements 20, and may be made of translucent plastic so that they too appear to light up when the lighting elements are activated. Each eyecup 18 is glued or otherwise adhered to frame 12 (See FIG. 5).

FIG. 3 depicts the frame 12 from the rear. The rectangular area shown at 22, having a removable cover, houses the circuitry and the batteries (shown in dashed lines) for the eyewear, including the lighting elements.

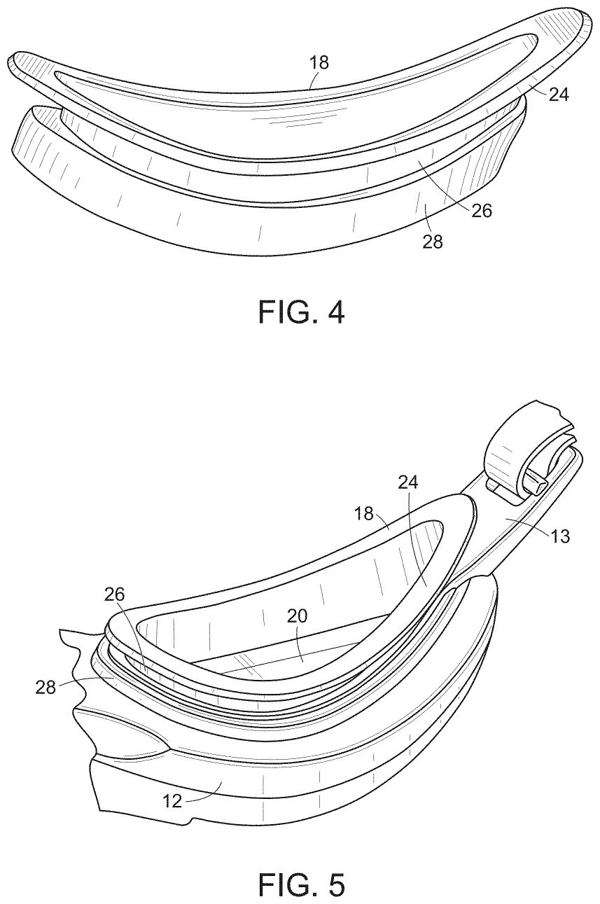

FIG. 4 depicts eyecup 18, which includes perimetral rim 24, recessed portion 26, and base portion 28. Eyecup 18 is preferably formed of soft translucent plastic. Base portion 28 is glued or otherwise adhered to the frame as shown in FIG. 5. Because the material of eyecup 18 is soft plastic, the eyewear (for example, swimming googles) may be tightly fitted to the user's head while the flexibility of the soft plastic eyecup ensures a comfortable and watertight fit to the face of the user.

FIG. 6 is a circuit diagram of the circuitry that may be employed in one aspect of the invention. Transistors Q1 and Q2 act as an amplifier. As soon as the circuit is “closed”−i.e., when contacts 16 are immersed in water—the LEDs 1-4 light up. Capacitor C1 stores energy so that, when the eyewear is removed from the water and the electrical circuit opens, the LEDs will remain lit for a selected amount of time (for example, for about 10 seconds) by means of the energy stored in the capacitor, and then the LEDS will turn off.

From the description of at least one embodiment of the present disclosure, various alterations, modifications, and improvements will readily occur to those skilled in the art. Such alterations, modifications, and improvements are intended to be within the scope and spirit of the disclosure. Accordingly, the foregoing description is by way of example only and is not intended to be limiting.

While several embodiments of the present invention have been described and illustrated herein, those of ordinary skill in the art will readily envision a variety of other means and/or structures for performing the functions and/or obtaining the results and/or one of more of the advantages described herein, and each of such variations and/or modifications is deemed to be within the scope of the present invention. More generally, those skilled in the art will readily appreciate that all parameters, dimensions, materials, and configurations described herein are mean to be exemplary and the actual parameters, dimensions, materials and/or configurations will depend upon the specific application or applications for which the teachings of the present invention is/are used. Those skilled in the art will recognize or be able to ascertain using no more than routine experimentation, many equivalents to the specific embodiments of the invention described herein. It is therefore to be understood that the foregoing embodiments are presented by way of example only and that, with the scope of the appended claims and equivalents thereto, the invention may be practiced otherwise than as specifically described and claimed. The present invention is directed to each individual feature, system, article, material, and/or method

I claim:

1. Eyewear, comprising:
a frame;
a lens area defined by the frame;
a lens positioned in the lens area;
at lighting element secured to the frame;
a power source associated with the at least one lighting element;
a pair of electrical contacts positioned at a surface of the frame and configured to complete a circuit between the source of power and the lighting element to activate the lighting element when the contacts are immersed in water.

2. The eyewear of claim 1, wherein lighting element is configured to remain activated for a selected period of time after removing the pair of electrical contacts from water.

3. The eyewear of claim 1, further comprising a filament located proximate to the lens, wherein the filament is configured and positioned to receive and reflect light from the lighting element.

4. The eyewear of claim 3, further comprising a filament located proximate to the lens, wherein the filament is configured and positioned to receive and reflect light from the lighting element.

5. The eyewear of claim 1, wherein the frame is made, at least in part, of soft, flexible plastic.

6. Eyewear, comprising:
a frame comprising a first member and a second member, the first member and the second member being joined to each other;
a lens area at least partially defined by the frame;
a lens positioned in the lens area;
a lighting element positioned between the first member and the second member of the frame;
a filament positioned between the first member and second member of the frame and proximate to the lens, wherein the filament is configured and positioned to receive and reflect light from the lighting element.

7. Eyewear, comprising:
a frame member made at least in part of translucent material;
a lighting element attached to the frame;
a power source associated with the lighting element;
a pair of electrical contacts positioned at a surface of the frame and configured to complete a circuit between the source of power and the lighting element to activate the lighting element when the contacts are immersed in water, thereby illuminating the translucent part of the frame member.

8. The eyewear of claim 7, wherein the frame is made, at least in part, of soft, flexible plastic.
